(19) United States
(12) Patent Application Publication
(10) Pub. No.: US 2004/0164554 A1
(43) Pub. Date: Aug. 26, 2004

(54) Assembly for joining metallic pipes provided with inner plastic liner

(76) Inventor: Jose Miguel Cabezas, Conroe, TX (US)

Correspondence Address: ROBERT D. FISH; RUTAN & TUCKER, LLP, P.O. BOX 1950, 611 ANTON BLVD., 14TH FLOOR, COSTA MESA, CA, 92628-1950, US

(21) Appl. No.: 10/753,672

(22) Filed: Jan. 7, 2004

Related U.S. Application Data
(60) Provisional application No. 60/439,052, filed on Jan. 8, 2003.

(51) Int. Cl. F16L 55/00

(52) U.S. Cl. 285/405; 285/328; 285/55

(57) ABSTRACT

A pipe flange apparatus includes a first pipe flange having a frontal face surrounding a central bore passing through the flange, the face comprising an internal flange recess extending into the flange and surrounding the bore, and a groove extending into the flange and surrounding the internal flange recess, wherein the internal flange recess comprises a textured surface at least partially surrounding the bore. Some such apparatus may also have an internal flange having first and second portions surrounding a bore extending through the internal flange, wherein the first portion is positioned at least partially within the internal flange recess of the first pipe flange and in contact with the textured surface of the first pipe flange. In at least some embodiments the second portion extends into the bore, and a first sealing ring positioned at least partially within the groove surrounding the internal flange recess. Some such apparatus may also have a second pipe flange similar to the first pipe flange in regard to the internal flange recess and a second internal flange similar to the first internal flange.

This application claims the benefit of U.S. provisional application No. 60/439052 incorporated herein by reference in its entirety.

### FIELD OF THE INVENTION

The invention relates to a flange assembly for joining high pressure pipes and more specifically, to the joints of metallic pipes with a plastic liner, oriented to the transport of corrosive or abrasive materials.

### BACKGROUND OF THE INVENTION

State of the art for this field has several technical solutions for joining metallic pipes having a plastic coating.

U.S. Pat. No. 4,643,457 reveals an assembly of pipe joints with plastic internal liner in which said inner liner is flared radially outwardly orthogonal to pipes symmetry axes, as plastic flanges, being these projections trapped by a couple of circular gaskets which are trapped by a couple of metallic flanges, wherein these metal joining flanges trap a part of the metallic external pipe that has also been projected orthogonal to pipes axes. Metallic flanges, are kept fixed by a plurality of bolts located near to the external edges.

Although is true that this document reveals an effective solution, this is not economically attractive because at least two gaskets are needed, and also working the external metallic border of the pipes to be joined is required.

U.S. Pat. No. 4,127,287 relates to joints between pipes sections with an inner plastic liner provided with said internal liner flared radially outwardly orthogonal to the pipes symmetry axes, as plastic seals. Such flared plastic projections are press to each other by a couple of metal rings between the flanges which are located toward the external border as an annular groove. The metal rings are fixed by several bolts externally located near to the border of the flange around its periphery.

Although is true that this document discloses an effective solution, this is not economically attractive because it requires an annular machining for accommodating a metallic ring o gasket which finally is the one that assures the seal of the pipes.

U.S. Pat. No. 5,573,282 relates to an assembly of pipe joints with a plastic inner liner, in which a plastic flange is housed in the interior of the pipe and is projected orthogonal to pipes symmetry axis which are going to be joined. Said plastic flange has two extensions that fit on the corresponding annular groove of the external metallic flanges to assure the fixation and sealing of the plastic flanges. The metal rings are fixed by several bolts externally located near to the border of the flange around its periphery.

Even when is true that this document describes an effective solution, it is not economically attractive because it requires at least two machining on the faces to be joined and also manufacturing of plastic flanges with projections for fixation and assurance of pipe sealing.

U.S. Pat. No. 3,771,817 discloses an assembly of pipe joints with a plastic inner liner, in which a flange of plastic housed in the interior of the pipe is projected orthogonal to pipes symmetry axis which are going to be joined. Such flanges are pressed by a couple of metallic rings which have a side with an angle of machining higher than 90 degrees respect to the symmetry axes of the pipe; in such a way the external part of the metallic flange (higher diameter) provides a bigger tightening surface than in the center of the metallic flange. The metallic flanges are further assured by several bolts externally located near to the border of the flange around its periphery.

Even when is true that the last document provides a simple and less costly solution than the previous ones it is not totally effective because the sealing is obtained practically in the external border of the metallic flange and not from the center of it.

### SUMMARY OF THE INVENTION

The invention is targeted to the improvement of a flange assembly for joining high pressure pipes and more specifically to the joining of metallic pipes with inner plastic liners oriented to the transport of corrosive or abrasive materials. Such an assembly is constituted essentially by a couple of metallic flanges, a couple of plastic flanges and a couple of annular packings (o-rings), each metallic flange having an annular disk like recess with the recess having an indented groove in order to assure the seal and anchorage of each plastic flange in said annular recess of the metallic flange.

A further improvement of this invention is done by implementing an additional o-ring between the couple of plastic flanges beyond one originally established for the metal flanges. It also allocate one of said O-rings between the couple of plastic flanges in a single annular groove which is on one side of the faces and the other of said O-rings is allocated between the pair of metallic flanges which is a single annular groove over one single face.

An objective of the present invention is to get a safety sealing of precise and easy alignment for working at high pressures using the minimum number of possible elements and therefore at the low cost. This objective may be accomplished via a preferred pipe flange apparatus includes a first pipe flange having a frontal face surrounding a central bore passing through the flange, the face comprising an internal flange recess extending into the flange and surrounding the bore, and a groove extending into the flange and surrounding the internal flange recess, wherein the internal flange recess comprises a textured surface at least partially surrounding the bore. Some such apparatus may also have an internal flange having first and second portions surrounding a bore extending through the internal flange, wherein the first portion is positioned at least partially within the internal flange recess of the first pipe flange and in contact with the textured surface of the first pipe flange. In at least some embodiments the second portion extends into the bore, and a first sealing ring positioned at least partially within the groove surrounding the internal flange recess. Some such apparatus may also have a second pipe flange similar to the first pipe flange in regard to the internal flange recess and a second internal flange similar to the first internal flange.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

The drawings included here for a better understanding of the invention, illustrate an embodiment of the invention in order to explain the principles of it:

FIG. 1 is a frontal top perspective view of a flange embodying the invention.

FIG. 2 is a rear top perspective view of the flange of FIG. 1.

FIG. 3 is a frontal view of the flange of FIGS. 1 and 2.

FIG. 4 is a back view of the flange of FIGS. 1-3.

FIG. 5 is an exploded half cross-section profile of a flange assembly including the flange of FIGS. 1-5 and components associated with the flange.

FIG. 6 is an assembled view of the assembly of claim 5.

FIG. 7 is an enlarged view of detail A of the assembly of FIG. 6.

FIG. 8 is a half cross section view an apparatus comprising the assembly of FIGS. 5 and 6 coupled to a mating flange assembly.

FIG. 9 is an explosion view in half cross section of an alternative apparatus comprising two coupled flange assemblies.

FIG. 10 is an assembled view of the apparatus of claim 9.

### DETAILED DESCRIPTION

Description of the present invention is now made with reference to the figures for the joining of high pressure pipes.

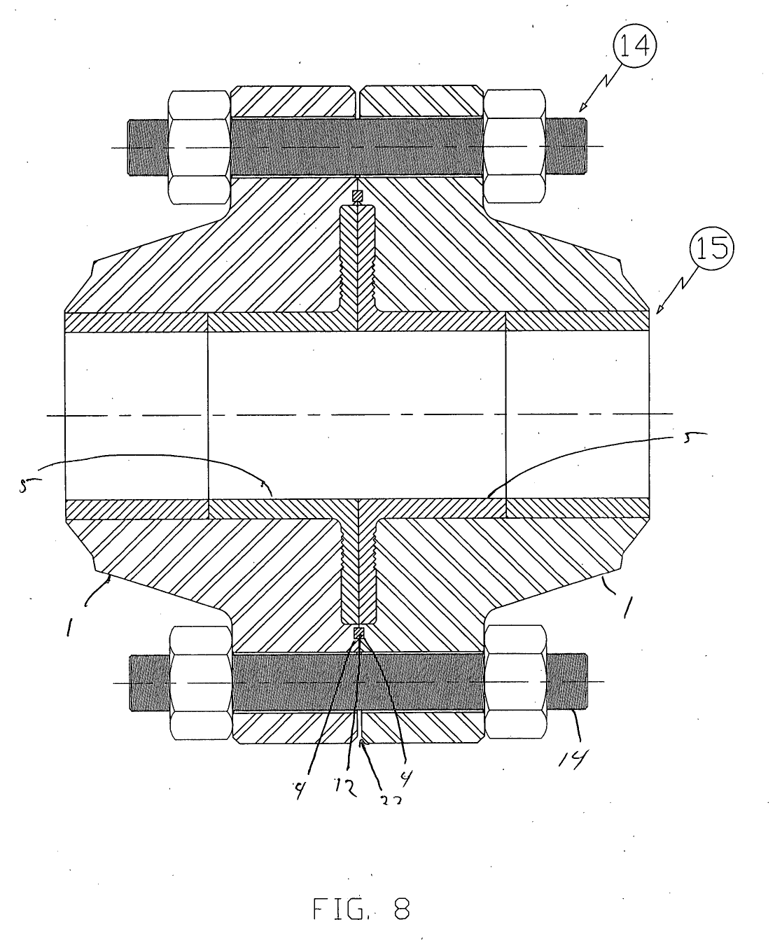

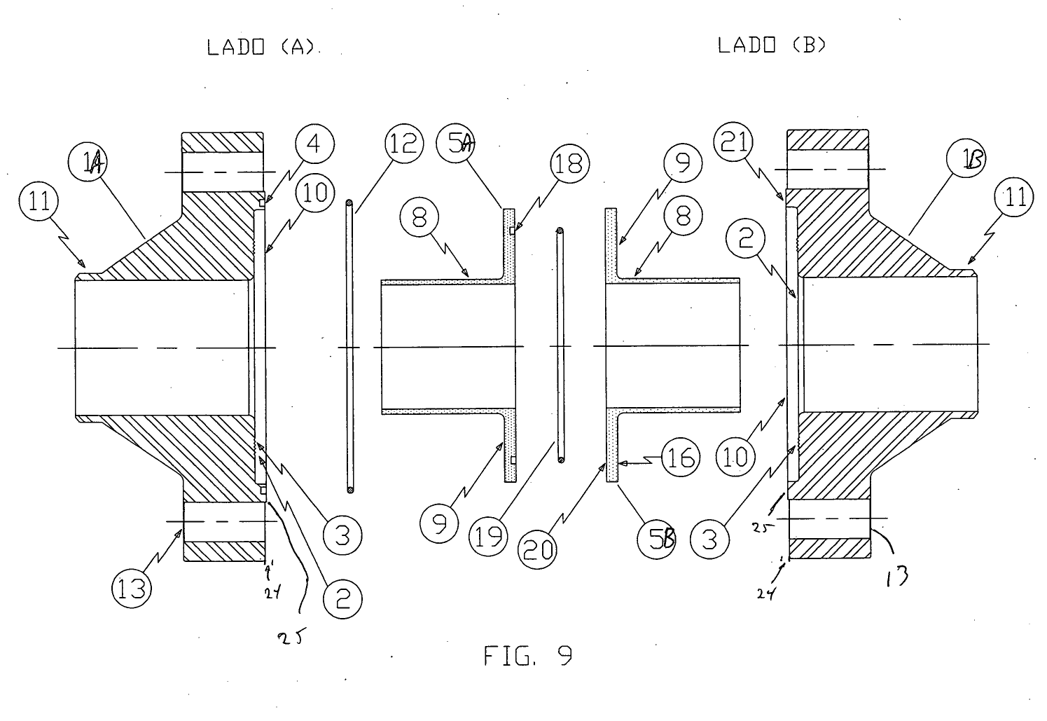

A preferred embodiment of the present invention includes a metallic flange 1 which has a frontal face 10 for joining with another flange, and a back face 11 to be welded to a steel pipe (not shown); the frontal face 10 for joining includes a first substantially disk shaped machining recess 2 having a surface over a portion of which are indenting type grooves 3. Frontal face 10 also includes a second machined recess 4 in the form of a groove for receiving an annular packing of squared section (o-ring) 12. Metallic flange 1 also has a plurality of diametrally deployed boreholes 13 positioned next to its external edge, for positioning bolts (14 in FIG. 8) which will tighten the assembly as needed for appropriate coupling and sealing with another flange. The metallic flange 1 is positioned and coupled (generally by being buttwelded) to a metallic pipe (not shown) having an inner plastic liner (15 in FIG. 8). Flange 1 also comprises bore 23 passing through flange 1 where bore 23 extends the bore of a pipe to which flange 1 is coupled.

The metallic flange 1 includes recess 2 in order to accommodate a plastic flange 5 having a first portion 8 parallel to the symmetry axes of he pipes being joined, and a second portion 9 that projects orthogonally from the first portion 8. The orthogonal portion 9 of the plastic flange 5 partially fills the cavity 2 while joining the two frontal faces 10 of the two metallic flanges 1 generating in this way a gap 7. During mounting of the assembly, when tightening the bolts 14 positioned within the boreholes 13 of the metallic flange 1, said second orthogonal portion 9 of the plastic flange 5 is compressed and it flows to fill the gaps between the indenting grooves 3 of the first recess 2, and it also extends to further fill the gap 7 to provide a seal preventing flow between metallic flange 1 and plastic flange 5. To further secure said sealing, the assembly also includes an o-ring 12 which is positioned in groove 4.

A person skilled in the art will appreciate that there are several ways for realizing the present invention, wherein, for instance, the indenting grooves 3 can have the form either of a knurled or any other type of machining able for generating small gaps in such a way that the portion 9 of the plastic flange 5 can flow toward these gaps and fix to the metallic flange 1.

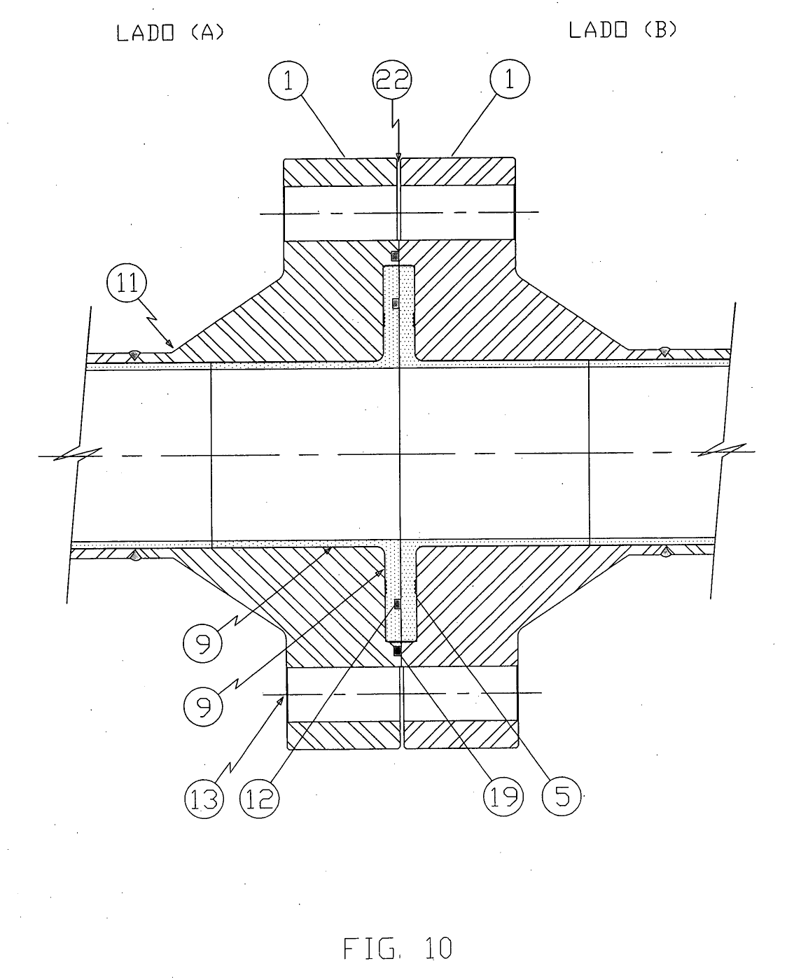

A more preferred embodiment is shown in FIGS. 9 and 10 where an assembly comprising two similar but not identical metallic flanges 1A and 1B and plastic flanges 5A and 5B are constituted by a face (A) subassembly and a face (B) subassembly, and two annular packings (12, and 19) also known as o-rings. Flanges 1A and 5A differ from flanges 1B and 5B in that flanges 1A and 5A incorporate grooves 4 and 18 while flanges 1B and 5B do not have comparable grooves.

Portion 8 of the plastic flange 5A of face (A) is inserted into the metallic flange 1A, so as to place the orthogonal portion 9 in contact with the indented surface 3 of the machined recess 2. Similarly, portion 8 of the plastic flange 5B of face (B) is inserted into the metallic flange 1B so as to place the orthogonal portion 9 in contact with the indented surface 3. Other than groove 18 of flange 5A, the joining faces of the plastic flanges 5A and 5B are flat.

An o-ring 19 is positioned in groom 18 of face (A) of the plastic flange 5A and will be compressed into groove 18 when bolts in boreholes 13 coupling flanges 5A and 5B together are tightened. Compression of o-ring 19 into groove 18 occurs because the joining face of the plastic flange 5B of face (B) is flat and does not include a corresponding groove 18. As such, portion 20 of flange 5B that is positioned opposite groove 18 of flange 5A will compress the o-ring 19 in a manner that causes o-ring 19 to be completely housed inside the annular groove 18 of the plastic flange 5A on face (A), creating thereby a seal that inhibits flow between flanges 5A and 5B from the flowpath formed by the bores of flanges 5A and 5B.

Excessive compression and a high volume shift of plastic material in the plastic flange 5 is avoided at least in part because of incorporation of o-ring 19. Such excessive compression represents an inconvenience in the long term due to strength loss or decompression by fatigue where sealing depends only upon compression of the plastic flange. Additionally, excessive compression of portion 9 of the plastic flanges may cause material flow in a radial form toward the inside of the flange set creating therefore an undesired bulge in the internal diameter of the pipe which provokes a turbulent flow.

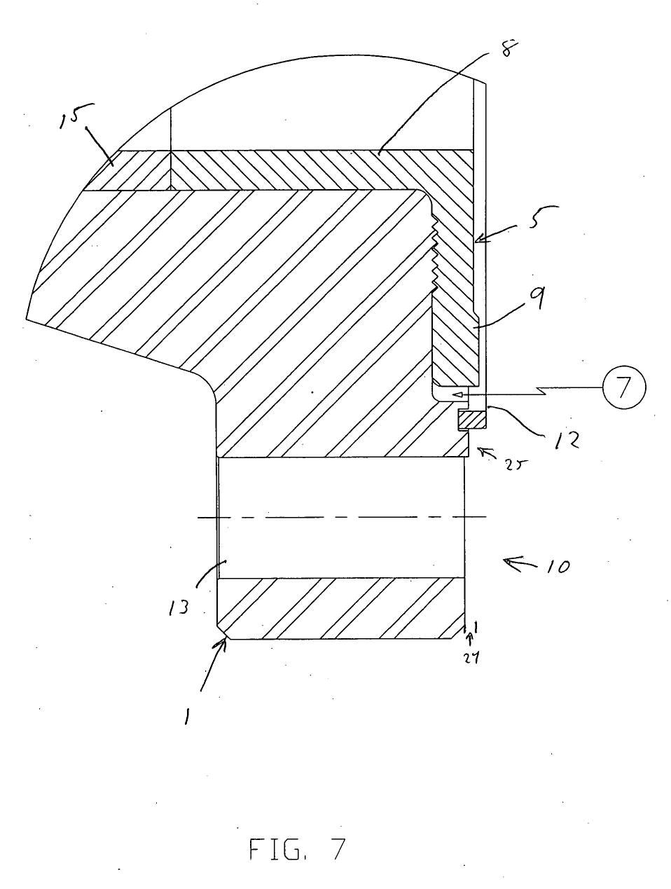

As portion 9 of flanges 5A and 5B are not compressed more than necessary to form a seal with o-ring 19, there is no need for a gap (7 in FIG. 7) as the volume or space for the compressed plastic flow of the plastic flange 5 is not required anymore. As such, the diameter of the recess 2 of the embodiment of FIGS. 9-10 matches the diameter of the orthogonal portion 9. Moreover, the thickness of the orthogonal portion 9 of the plastic flanges 5A and 5B can also be reduced which allows for faster assembly and results in reduced strain of the bolts 14.

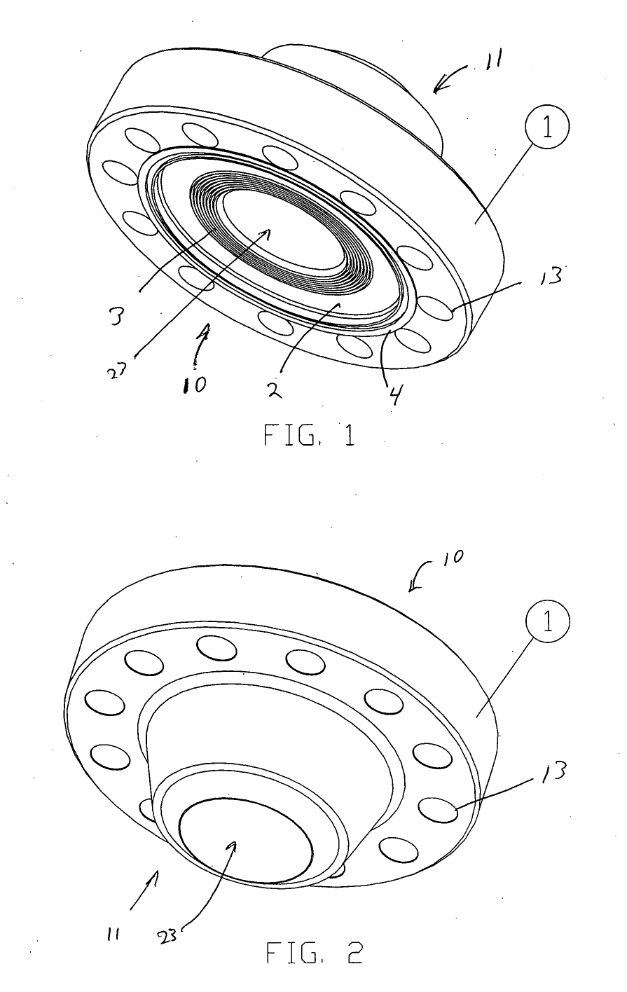

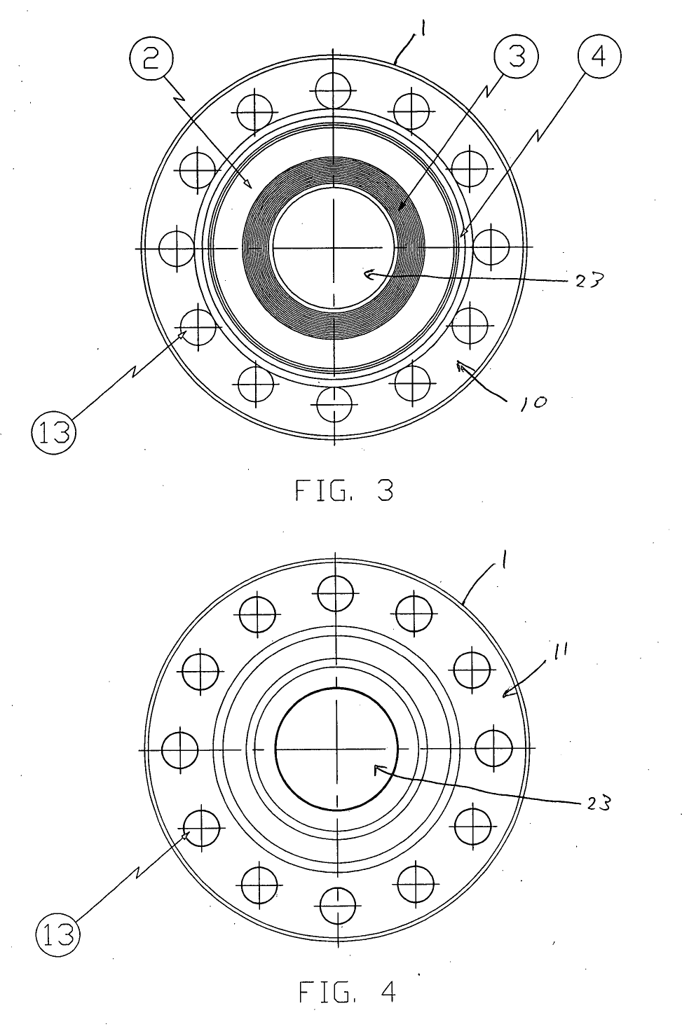

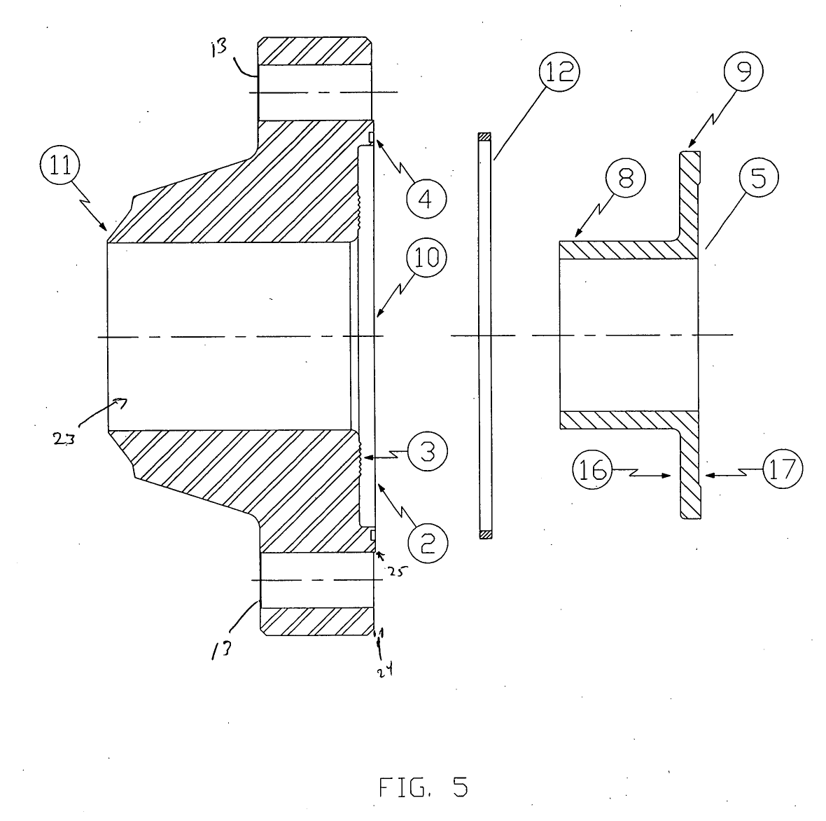

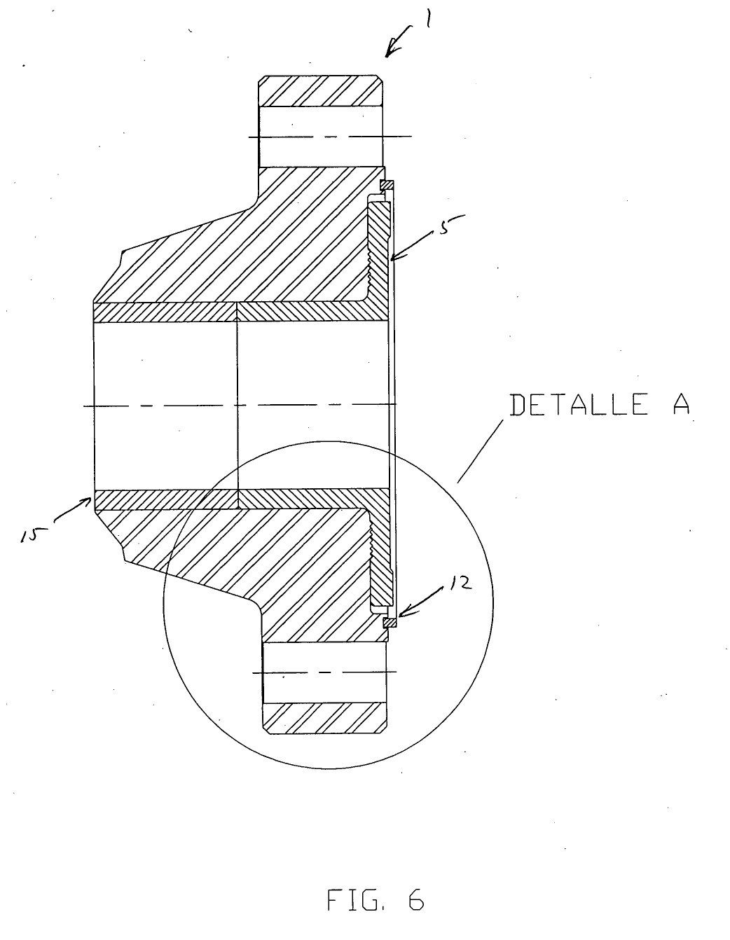

In a manner similar to flange 5A and groove 18, metallic flange 1A of face (A) also includes an annular groove 4 sized and dimensioned to receive an o-ring 12 of circular section. When bolts 14 are tightened, flat surface 21 of the metallic flange 1B of side (B) compresses the o-ring 12 to completely cover the second machined groove 4, creating then a secondary seal of high efficiency. This differs from the embodiment of FIGS. 1-8 in which the volume of the o-ring 12 was distributed into two annular grooves 4 of the metallic flanges.

It should be noted that positioning grooves 4 and 18 on a single fitting eliminates the need to carefully align the flanges of face (A) with those of face (B) as would be required if grooves on opposite faces had to be aligned. It also reduces the amount of precision required in forming such grooves as variances will no longer result in misalignment with opposing grooves.

It should also be noted that positioning grooves 4 and 18 on a single fitting allows for the metallic flange of side (A), and its components, to be used with other standard elements for joining while still creating an effective seal through the O-rings (12 and 19). Consequently a better compatibility in the connection of this special flange with more universal ones is obtained.

Each metallic flange 1, 1A and 1B has a recess 24 in the frontal diameter zone of the boreholes 13. Once tightening of the assembly is completed, a diametral contour space 22 is generated which is limited starting at the immediately inferior level of the circumferential axis or development of the boreholes of flanges 1. Providing contour space 22 results in increased stability of the assembly at least in part from more uniform distribution of the charge only over the bulge 25 of the faces 10 of the flanges 1A and 1B faces (A) and (B), and into a continuous distribution of the strength free of additional strains on the bolts under operational charges.

It is important to note that flange assemblies and pipe joining methods described herein embodies numerous novel features that, individually and in combination, distinguish it from prior art flange assemblies and pipe joining methods. As such, it may be characterized in a number of ways using one or more of such features. The following paragraphs provide some exemplary characterizations, but the list is not-exhaustive as other combinations are contemplated and would be readily apparent to one of average skill in the art after reading this disclosure.

A first characterization of a flange assembly as described herein is as an assembly for joining metallic pipes provided with inner plastic liner comprising: (a) a couple of metallic flanges 1 having a plurality of boreholes 13 positioned diametrally and near to the edges for positioning bolts 14 which will tighten the assembly as needed for an appropriate fixing and sealing; wherein said metallic flange 1 has a front face 10 for joining with a counter face 11, wherein said joining face 10 is orthogonal to the symmetry axes of the pipes to be joined; (b) a plastic flange 5 having a first portion 8 parallel to the symmetry axes of the pipes, and a second portion 9 orthogonal to said axes of symmetry of the pipes; and (c) an annular packing of squared section, or o-ring, wherein the front face of the joint 10 of the metallic flange 1 is provided with a first machined groove 2 over which there is a portion of notches 3, wherein said machined groove 2 destined to accommodate the orthogonal portion 9 of the plastic flange 5, wherein said front face 19 of the joint has a second machined groove 4 destined to accommodate said annular packing of squared section.

In some instances, such an assembly may also be characterized in that the orthogonal portion 9 of the plastic flange 5 partially fills the cavity generated at the initial joining and prior to tightening of the two frontal faces 10 of the metallic flanges 1 thereby generating a gap 7.

In such or alternative instances, such an assembly may also be characterized in that during mounting operation of said assembly the second orthogonal portion 9 of the plastic pipe 5 is compressed and flows until the spaces of the notches 3 of the first machined groove 2 are filled by means of tightening bolts 14 located on the boreholes 13 of the metallic flange 1.

In such or alternative instances, such an assembly may also be characterized in that during mounting operation of said assembly the second orthogonal portion 9 of the plastic pipe 5 is compressed and flows and extends to fill in also the gap 7 by means of tightening bolts 14 located on the boreholes 13 of the metallic flange 1.

In such or alternative instances, such an assembly may also be characterized in that the notches 3 may have an indented, knurled or other machined form that generate small gaps so that portion 9 of the plastic flange 5 can be fixed on the metallic flange 1, and further provide a high pressure seal between the real surface 16 of the orthogonal portion 9 of the plastic flange 5 and the surface from the first machined groove 2 of the metallic flange 1.

In such or alternative instances, such an assembly may also be characterized in that during mounting operation of said assembly, the second orthogonal portion 9 of the plastic pipe 5 is compressed and flows and extends to fill in the gap 7 by means of tightening bolts 14 located on the boreholes 13 of the metallic flange 1 and providing further a primary high pressure seal between the frontal surfaces 17 of the orthogonal portion 9 of both plastic flanges 5 that constitute the assembly.

A second characterization of a flange assembly as described herein is as an assembly for joining metallic pipes provided with inner plastic liner comprising: (a) a couple of metallic flanges 1 located on sides (A) and (B) of the ensemble wherein said metallic flanges 1 have a plurality of boreholes 13 positioned diametrally and near to their edges for positioning bolts 14 which will tighten the assembly as needed for an appropriate fixing and sealing; wherein said metallic flange 1 has a frontal face 10 for joining and a counter face 11 wherein said joining face 10 is orthogonal to the symmetry axes of the pipes to be joined; (b) a couple of plastic flanges 5 located on sides (A) and (B) of the ensemble wherein said flanges 5 have a first portion 8 parallel to the symmetry axes of pipe, and a second portion 9 orthogonal to said axes of symmetry of the pipes; and (c) an annular packing or o-ring 12, wherein the frontal face of the joint 10 of the metallic flange 1 is provided with a first machined groove 2 over which there is a portion of notches 3, wherein said machined groove 2 is destined to accommodate the orthogonal portion 9 of the plastic flange 5, wherein said frontal face 10 of the joint has a second machined groove 4 destined to accommodate said annular packing or o-ring 12; wherein the joining faces of the plastic flanges 5 are flat and incorporate between them an o-ring 19, wherein said o-ring 19 is designed to be positioned into an annular groove 18 of side (A) of the plastic flange 5, wherein the joining counter face of the plastic flange 5 of side (B) is flat, having a portion 20 located on it and compress the o-ring 19 to be allocated entirely on the annular groove 18 of the plastic flange 5 of side (A) creating a primary sealing; and wherein the metallic flange 1 of side (A) has an annular groove 4 for allocating an o-ring 12 of circular section which on tightening bolts 14 allows for the flat surface 21 of the metallic flange 1 of side (B) compress the o-ring 12 to completely cover the second machined groove 4 creating a secondary seal.

In such or alternative instances, such an assembly may also be characterized in that portion 8 of the plastic flange 5 of side (A) is introduced into the metallic flange 1 of side (A) until touching the orthogonal portion 9 with an indented surface 3 of the machined groove 2, wherein the diameter of groove 2 is matched with the diameter of the orthogonal portion 9.

In such or alternative instances, such an assembly may also be characterized in that the o-rings (12 and 19) have circular section.

In such or alternative instances, such an assembly may also be characterized in that during mounting operation of said assembly the second orthogonal portion 9 of the plastic pipe 5 is compressed and flows until the spaces of the notches 3 of the first machined groove 2 are filled by means of tightening bolts 14 located on the boreholes 13 of the metallic flange 1.

In such or alternative instances, such an assembly may also be characterized in that the notches 3 may have an indented, knurled or other machined form that generate small gaps so that portion 9 of the plastic flange 5 can be fixed on the metallic flange 1 and further provide a high pressure seal between the real surface 16 of the orthogonal portion 9 of the plastic flange 5 and the surface from the first machined groove 2 of the metallic flange 1.

A third characterization of a flange assembly as described herein is as a pipe flange apparatus comprising a first pipe flange having a frontal face surrounding a central bore passing through the flange, the face comprising an internal flange recess extending into the flange and surrounding the bore, and a groove extending into the flange and surrounding the internal flange recess, wherein the internal flange recess comprises a textured surface at least partially surrounding the bore. A “textured surface”, as the term is used herein, is a surface formed with gaps or other features adapted to engage a surface of a plastic flange in order to form a better seal with, and/or to better retain the plastic flange.

In such or alternative instances, such an assembly may also be characterized in that: the groove is substantially circular and the internal flange recess is disk shaped, and the diameter of the groove is greater than the diameter of the internal flange recess; the flange comprises a plurality of boreholes extending through the flange and positioned radially around the groove; and or the groove has a depth less than that of the internal flange recess.

In such or alternative instances, such an assembly may also be characterized as also including an internal flange having first and second portions surrounding a bore extending through the internal flange, wherein the first portion is positioned at least partially within the internal flange recess of the first pipe flange and in contact with the textured surface of the first pipe flange and the second portion extends into the bore, and a first sealing ring positioned at least partially within the groove surrounding the internal flange recess.

In such or alternative instances, such an assembly may also be characterized in that: the first portion of the internal flange is sized and positioned such that it substantially fills all of the internal flange recess but does extend radially outward from the internal flange recess; the flange is coupled to a lined pipe having a central liner that is separate from the internal flange, and extends into the central bore of the first extends into the central bore of the first pipe flange such that the liner and the second portion of the internal flange line the central bore of the first pipe flange; and/or the internal flange comprises a first surface adjacent to the textured surface, a second surface opposite the first surface, and a groove surrounding the internal flange bore and extending into the internal flange from the second surface.

In such or alternative instances, such an assembly may also be characterized as also including a second sealing ring positioned at least partially within the internal flange groove.

In such or alternative instances, such an assembly may also be characterized as also including a second pipe flange coupled to the first pipe flange, the second pipe flange having a frontal face surrounding a bore passing through the second pipe flange, the face of the second pipe flange comprising an internal flange recess extending into the second pipe flange and surrounding the bore of the second pipe flange, wherein the internal flange recess of the second pipe flange comprises a textured surface surrounding the bore of the second pipe flange; and a second internal flange having first and second portions surrounding a bore extending through the second internal flange, wherein the first portion is positioned at least partially within the internal flange recess of the second pipe flange and in contact with the textured surface of the second pipe flange and the second portion extends into the central bore of the second pipe flange.

In such or alternative instances, such an assembly may also be characterized in that neither the second pipe flange nor the second internal flange has a groove sized and positioned to receive either the first sealing ring or the second sealing ring.

For the sake of the simplicity in the discussion of the described embodiments of the present invention the term “plastic” was used to identify and refer to the pipe liner and liner flanges and the term “metallic” was used to identify and refer only to the lined exterior pipes being joined and the flanges used to join them. It is to be understood that other specific materials may be used within the spirit of the present invention. For example while a particular plastic which is commonly used for pipe liners is high density polyethylene (HDPE), other plastics, elastomers, composites and similar materials may be equally suitable. Similarly, while the exterior pipe is most commonly made of steel, other metals, plastics and/or composites may also be suitable.

Thus, specific methods and apparatus for joining high pressure pipes have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A pipe flange apparatus comprising a first pipe flange having a frontal face surrounding a central bore passing through the flange, the face comprising an internal flange recess extending into the flange and surrounding the bore, and a groove extending into the flange and surrounding the internal flange recess, wherein the internal flange recess comprises a textured surface at least partially surrounding the bore.

2. The apparatus of claim 1 wherein the groove is substantially circular and the internal flange recess is disk shaped, and the diameter of the groove is greater than the diameter of the internal flange recess.

3. The apparatus of claim 2 wherein the flange comprises a plurality of boreholes extending through the flange and positioned radially around the groove.

4. The apparatus of claim 3 wherein the groove has a depth less than that of the internal flange recess.

5. The apparatus of claim 1 further comprising:
an internal flange having first and second portions surrounding a bore extending through the internal flange, wherein the first portion is positioned at least partially within the internal flange recess of the first pipe flange and in contact with the textured surface of the first pipe flange and the second portion extends into the bore; and
a first sealing ring positioned at least partially within the groove surrounding the internal flange recess.

6. The apparatus of claim 5 wherein the first portion of the internal flange is sized and positioned such that it substantially fills all of the internal flange recess but does extend radially outward from the internal flange recess.

7. The apparatus of claim 6 wherein the flange is coupled to a lined pipe having a central liner that is separate from the internal flange, and extends into the central bore of the first extends into the central bore of the first pipe flange such that the liner and the second portion of the internal flange line the central bore of the first pipe flange.

8. The apparatus of claim 5 wherein the internal flange comprises a first surface adjacent to the textured surface, a second surface opposite the first surface, and a groove surrounding the internal flange bore and extending into the internal flange from the second surface.

9. The apparatus of claim 8 further comprising a second sealing ring positioned at least partially within the internal flange groove.

10. The apparatus of claim 8 further comprising:
a second pipe flange coupled to the first pipe flange, the second pipe flange having a frontal face surrounding a bore passing through the second pipe flange, the face of the second pipe flange comprising an internal flange recess extending into the second pipe flange and surrounding the bore of the second pipe flange, wherein the internal flange recess of the second pipe flange comprises a textured surface surrounding the bore of the second pipe flange; and
a second internal flange having first and second portions surrounding a bore extending through the second internal flange, wherein the first portion is positioned at least partially within the internal flange recess of the second pipe flange and in contact with the textured surface of the second pipe flange and the second portion extends into the central bore of the second pipe flange.

11. The apparatus of claim 10 wherein neither the second pipe flange nor the second internal flange has a groove sized and positioned to receive either the first sealing ring or the second sealing ring.
